(19) United States
(12) Patent Application Publication
(10) Pub. No.: US 2026/0195088 A1
(43) Pub. Date: Jul. 9, 2026

(54) ELECTRONIC PAPER DISPLAY DEVICE

(71) Applicant: E Ink Holdings Inc., Hsinchu (TW)

(72) Inventor: Jia-Hong Xu, Hsinchu (TW)

(73) Assignee: E Ink Holdings Inc., Hsinchu (TW)

(21) Appl. No.: 19/438,636

(22) Filed: Jan. 1, 2026

(30) Foreign Application Priority Data
Jan. 9, 2025 (TW) 114100927

(51) Int. Cl. G06F 3/147

(52) U.S. Cl. CPC G06F 3/147

(57) ABSTRACT

An electronic paper display device including an electronic tag, a processor circuit, and an electronic paper display panel is provided. The electronic tag is configured to segmentally receive image data from a data transmitter. The processor circuit is coupled to the electronic tag. The processor circuit is configured to determine whether to read the image data from the electronic tag based on a read signal. The electronic paper display panel is coupled to the processor circuit. The electronic paper display panel is configured to receive the image data from the processor circuit to display an image picture.

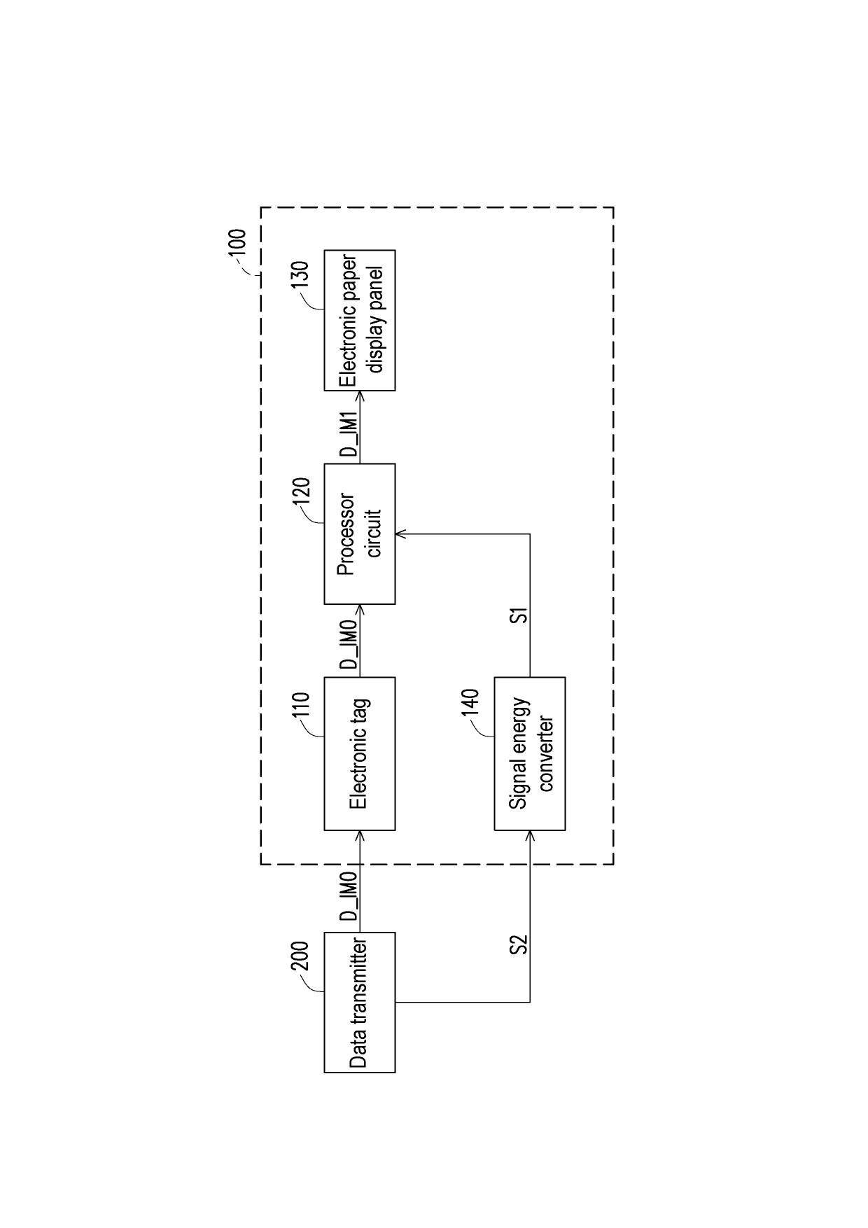

### CROSS-REFERENCE TO RELATED APPLICATION

This application claims the priority benefit of Taiwan application serial no. 114100927, filed on January 9, 2025. The entirety of the above-mentioned patent application is hereby incorporated by reference herein and made a part of this specification.

### BACKGROUND

### Technical Field

The disclosure relates to a display device, and particularly relates to an electronic paper display device.

### Related Art

Common ultra high frequency (UHF) tags are usually used independently in the chips inside item tags, such as item tags used for retail or logistics, and are mostly discarded along with the item tags. UHF tags are not integrated with peripheral devices, and are rarely combined with displays for other applications. Moreover, UHF tags generally do not support transmission of a large amount of image data.

### SUMMARY

The disclosure provides an electronic paper display device with an electronic tag, which supports transmission of image data and provides a good user experience.

The electronic paper display device according to an embodiment of the disclosure includes an electronic tag, a processor circuit, and an electronic paper display panel. The electronic tag is configured to segmentally receive image data from a data transmitter. The processor circuit is coupled to the electronic tag. The processor circuit is configured to determine whether to read the image data from the electronic tag based on a read signal. The electronic paper display panel is coupled to the processor circuit. The electronic paper display panel is configured to receive the image data from the processor circuit to display an image picture.

To make the above-mentioned features and advantages of the disclosure easier to understand, exemplary embodiments will be described in detail hereinafter in conjunction with the accompanying drawings.

### BRIEF DESCRIPTION OF THE DRAWINGS

The Figure is a block diagram showing an electronic paper display device according to an embodiment of the disclosure.

### DESCRIPTION OF THE EMBODIMENTS

In this specification (including the claims), the term "couple (or connect)" may refer to any direct or indirect connection means. For example, if it is described that a first device is coupled (or connected) to a second device, it should be interpreted that the first device may be directly connected to the second device, or the first device may be indirectly connected to the second device through other devices or certain connection means. The terms "first", "second", etc. used in this specification (including the claims) are used to name elements or distinguish different embodiments or ranges from each other, and are not intended to define the upper or lower limit of the number of elements, nor to limit the order of elements.

Moreover, where possible, elements/components/steps denoted by the same reference numerals in the drawings and embodiments represent the same or similar parts. Descriptions of elements/components/steps denoted by the same reference numerals or represented by the same terms in different embodiments may serve as reference for each other.

The Figure is a block diagram showing an electronic paper display device according to an embodiment of the disclosure. Referring to the Figure, an electronic paper display device 100 has an ultra high frequency (UHF) image data continuous segment transmission architecture, and may be configured to receive image data D_IM0 continuously and segmentally from a data transmitter 200. The data transmitter 200 is, for example, a read-write transmitter that uses UHF to transmit the image data D_IM0. Specifically, the electronic paper display device 100 includes an electronic tag 110, a processor circuit 120, an electronic paper display panel 130, and a signal energy converter 140. The electronic tag 110 is, for example, a UHF tag.

The electronic tag 110 serves as the receiving end of the electronic paper display device 100, and is configured to receive the image data D_IM0 segmentally from the data transmitter 200. The image data D_IM0 is, for example, radio frequency (RF) data. The image data D_IM0 includes multiple image data segments, and the data transmitter 200 segmentally transmits the image data D_IM0 to the electronic tag 110. The electronic tag 110 stores the image data D_IM0 in a storage circuit therein.

The processor circuit 120 is coupled to the electronic tag 110. The processor circuit 120 is configured to determine whether to read the image data D_IM0 from the electronic tag 110 based on a read signal S1. In an embodiment, the transmission interface between the electronic tag 110 and the processor circuit 120 is, for example, an Inter-Integrated Circuit (I2C) interface.

The electronic paper display panel 130 is coupled to the processor circuit 120. The electronic paper display panel 130 is configured to receive image data D_IM1 from the processor circuit 120 to display an image picture.

The signal energy converter 140 is coupled to the processor circuit 120 and the data transmitter 200. The signal energy converter 140 is configured to receive a write signal S2 from the data transmitter 200. The signal energy converter 140 converts the write signal S2 into a read signal S1 with a low level (first level) or a high level (second level), and outputs the read signal S1 to the processor circuit 120.

In an embodiment, the transmission interface between the signal energy converter 140 and the processor circuit 120 is, for example, a General Purpose Input/Output (GPIO) interface. In an embodiment, the signal energy converter 140 is, for example, an RF-to-DC power converter, and configured to convert RF power (write signal S2) into a DC signal (read signal S1).

The data transmitter 200 is configured to write the image data D_IM0 into the storage circuit of the electronic tag 110. During data writing, the signal energy converter 140 receives RF energy so that the read signal S1 has a high level. The high-level read signal S1 is used to indicate that the data transmitter 200 is writing the image data D_IM0 into the electronic tag 110. In response to the read signal S1 being at a high level, the processor circuit 120 stops reading the image data D_IM0 from the electronic tag 110.

When the data writing is completed, the signal energy converter 140 is turned off, and the read signal S1 has a low level. The low-level read signal S1 is used to indicate that the data transmitter 200 has completed the operation of writing the image data D_IM0 into the electronic tag 110. Therefore, in response to the read signal S1 being at a low level, the processor circuit 120 may read an image data segment in the image data D_IM0 from the storage circuit of the electronic tag 110 through the I2C interface.

The data transmitter 200 determines whether to transmit the next image data segment to the electronic tag 110 according to the image data D_IM0 stored in the electronic tag 110. For example, the data transmitter 200 checks at intervals whether a command in the image data segment has been modified. If the command has been modified, it indicates that the previous image data segment has been read by the processor circuit 120, and the data transmitter 200 may transmit the next image data segment. When the processor circuit 120 confirms that the last image data segment has been received, the processor circuit 120 updates the electronic paper display panel 130 so that the electronic paper display panel 130 displays the image picture.

In an embodiment, the data length of the image data segment is fixed. The first byte of the data format is a command, which is used to record whether data can be transmitted now or the electronic tag 110 is in operation. The second byte is a count of the current segment packet. The third byte and beyond are the image data to be displayed.

The hardware structures of the electronic tag 110, the processor circuit 120, the electronic paper display panel 130, and the signal energy converter 140 may be sufficiently taught, suggested, and implemented through common knowledge in the relevant technical field.

In summary, according to the embodiments of the disclosure, data is transmitted through UHF, and the signal energy converter converts the energy into a GPIO pin signal, which enables the processor circuit to determine whether the data transmission has ended. When the transmission ends, the processor circuit obtains relevant information from the storage circuit in the electronic tag through the I2C interface. The processor circuit may obtain a complete picture to be displayed on the electronic paper display panel through repeated read operations.

Although the disclosure has been described with reference to the embodiments above, they are not intended to limit the disclosure. Any person skilled in the art may make modifications and changes without departing from the spirit and scope of the disclosure. Therefore, the protection scope of the disclosure should be defined by the appended claims.

What is claimed is:

1. An electronic paper display device, comprising:
an electronic tag configured to segmentally receive image data from a data transmitter;
a processor circuit coupled to the electronic tag and configured to determine whether to read the image data from the electronic tag based on a read signal; and
an electronic paper display panel coupled to the processor circuit and configured to receive the image data from the processor circuit to display an image picture.

2. The electronic paper display device according to claim 1, further comprising:
a signal energy converter coupled to the processor circuit and configured to output the read signal to the processor circuit.

3. The electronic paper display device according to claim 2, wherein the signal energy converter is configured to receive a write signal from the data transmitter and convert the write signal into the read signal.

4. The electronic paper display device according to claim 2, wherein a first level of the read signal indicates that the data transmitter is writing the image data into the electronic tag.

5. The electronic paper display device according to claim 4, wherein in response to the read signal being at the first level, the processor circuit stops reading the image data from the electronic tag.

6. The electronic paper display device according to claim 2, wherein a second level of the read signal indicates that the data transmitter has completed an operation of writing the image data into the electronic tag.

7. The electronic paper display device according to claim 6, wherein in response to the read signal being at the second level, the processor circuit reads the image data from the electronic tag.

8. The electronic paper display device according to claim 1, wherein the image data comprises a plurality of image data segments.

9. The electronic paper display device according to claim 8, wherein the data transmitter is configured to determine whether to transmit a next image data segment to the electronic tag according to image data stored in the electronic tag.

10. The electronic paper display device according to claim 9, wherein the processor circuit is configured to update the electronic paper display panel so that the electronic paper display panel displays the image picture when the processor circuit confirms that a last image data segment has been received.
